(19) United States
(12) Patent Application Publication
(10) Pub. No.: US 2009/0073206 A1
(43) Pub. Date: Mar. 19, 2009

(54) METHOD FOR OBTAINING AN IMAGE WITH AN INK JET PRINTER AND A PRINTER SUITABLE FOR PERFORMING THAT METHOD

(75) Inventor: Johannes M.M. SIMONS, Venlo (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 12/276,989

(22) Filed: Nov. 24, 2008

Related U.S. Application Data
(63) Continuation of application No. PCT/EP2007/054854, filed on May 21, 2007.

(30) Foreign Application Priority Data
May 24, 2006 (EP) 06114502.5

(51) Int. Cl. B41J 29/38

(52) U.S. Cl. 347/10

(57) ABSTRACT

A method obtains an image from multiple ink droplets transferred to a receiving substrate using an ink jet printer including a plurality of ink chambers operatively filled with ink. Each ink chamber has a nozzle and a corresponding transducer. The ink chambers have mutually distinguishable acoustics. The method includes, for the respective ink chambers, generating an electrical pulse, applying the pulse to the transducer corresponding to a respective ink chamber in order to generate a pressure wave in the ink, such that a droplet of the ink is jetted out of the nozzle at a speed corresponding to the pressure wave, and adjusting the pulse to the acoustics of the respective ink chamber such that the speed at which the droplet is jetted is essentially the same for each ink chamber. A printer is configured for application of the method.

### CROSS-REFERENCE TO RELATED APPLICATIONS

This application is a Continuation of International Application No. PCT/EP2007/054854, filed on May 21, 2007, and for which priority is claimed under 35 U.S.C. § 120, and claims priority under 35 U.S.C. § 119(a) to Application No. 06114502.5, filed in Europe on May 24, 2006. The entirety of each of the above-identified applications is expressly incorporated herein by reference.

### BACKGROUND OF THE INVENTION

1. Field of the Invention

The present invention relates to a method for obtaining an image from multiple ink droplets transferred to a receiving substrate using an ink jet printer including a plurality of ink chambers filled with ink, each of the plurality of ink chambers having a nozzle and a corresponding transducer. The present invention also relates to an ink jet printer including a controller arrangement that is configured to have the printer perform the method of the present invention.

2. Background of the Invention

In the background art, methods for using ink printers of the type indicated hereinabove are known. In such inkjet printers, an electrical pulse can be applied to a transducer (the pulse being any electrical signal that can be used to energize the transducer), whereupon the transducer (e.g. of the electro-mechanical or electro-thermal type) creates a pressure wave in the ink chamber due to the fact that the chamber is in essence (i.e. operatively) filled with ink, which is an incompressible fluid. The pressure wave will force a small volume of ink to be expelled from the nozzle. Depending on the properties of the pressure wave (e.g. amplitude, frequency, etc.) the size, shape and speed or other properties of the ink droplet that is expelled will vary. In the background art, methods have been suggested to deal with such variations, for example by performing an exact calibration of all the ink jet chambers from time to time and adjusting the print strategy to compensate for the measured differences. This can indeed be done, but is cumbersome and disadvantageous for print productivity. More importantly, since the ink droplet properties can vary over a relatively large range, this impacts the working latitude of the printer. In general, the chambers that lie at the borders of the working latitude determine the printer settings. This reduces the freedom of design and use of the printer and thus possibly the obtained print quality.

Other background art suggests to rule out any mechanical differences between the ink jet chambers, so that when actuating all chambers by using the same electrical pulse, this will result in the same pressure waves in each and every chamber. Thus, droplets with the same properties can be expelled from each chamber. In this way, calibration of individual chambers is no longer needed. However, it will be clear that making such a print head will be very expensive and thus economically less attractive.

### SUMMARY OF THE INVENTION

It is an object of the present invention to overcome these disadvantages. For this, a method of using an ink jet printer has been devised, wherein the chambers have mutually distinguishable acoustics. The method comprises, for the respective chambers (i.e. the chambers at the time when they are being used to obtain the image), generating an electrical pulse, applying the pulse to the transducer corresponding to a respective ink chamber in order to generate a pressure wave in the ink, such that a droplet of the ink is jetted out of the nozzle at a speed corresponding to the pressure wave, and adjusting the pulse to the acoustics of the respective ink chamber such that the speed at which the droplet is jetted is essentially the same for each ink chamber.

In this method, mechanical differences between the individual ink chambers, these differences leading to mutually distinguishable acoustics of these ink chambers, are accepted. But, instead of accepting the result of these acoustical differences, i.e. droplets with different properties, in particular droplet speed, applicant has recognized that it is far more advantageous to adjust the electrical pulse to the acoustics in order to obtain pressure waves in each of the ink chambers that lead to droplets having essentially the same ink droplet ejection speed (i.e. mutual speed differences are less than 10%, preferably less than 5%, more preferably less than 2% and most preferably less than 1% with regard to the droplet having the highest ejection speed). By applying this method, regular calibration of all individual ink chambers can in principle be dispensed with, or at least be performed at a far less intensive scheme. Also, by accepting mechanical differences between ink chambers, less stringent requirements are needed for production of ink jet print heads. For devising the method according to the present invention, use is made of the recognition that the pressure waves induced depend on the acoustics of the chambers themselves and the type of electrical pulse. This leads to the insight that mutual distinguishable acoustics can be accepted as they are, since the effect of the differences between these acoustics can be compensated for by controlled adjustment of the electrical pulses. In this way, despite acoustical differences between chambers, pressure waves can be induced that lead to ink droplets ejected at essentially the same speed for each chamber.

It will be clear for one having ordinary skill in the art that the present invention can also be applied for images that form part of a larger image. For example, for some applications it is adequate that the present invention is only applied for a sub-image of a complete image to be formed. For 3D modelling for example, it is typically sufficient to apply the present invention only for the sub-images that form the outermost parts of the 3D image. The inner parts are not visible, so image quality is often hardly important for those parts. In full-color printing, one could apply the present invention only for the most prominent color sub-images, for example the Black and Magenta images. Print quality is less of an issue for the Yellow sub-image. For whatever reason, one could also apply the present invention to some parts of an image, for example the center or lower parts of an image, those parts then correspond to an “image.” as defined herein. In short, the present invention can be applied for any image, no matter how this image is defined, that is part of a larger image.

In an embodiment, the transducer used is an electro-mechanical transducer that is operatively connected to the ink chamber. In this embodiment, use is made of a transducer, e.g. a piezoelectric or electrostatic transducer, which upon actuation induces a sudden volume-change of the chamber. With a piezo electric type of transducer, typically an electrical pulse is applied such that the chamber volume firstly increases which leads to “over-filling” of the chamber, whereafter the chamber is brought back to its equilibrium dimensions. The ink being in principal uncompressible, the latter change will lead to pressure waves that, if strong enough, ultimately lead to ejection of an ink droplet. Applicant has recognized that application of an electromechanical transducer, in particular a piezo electric transducer, is very advantageous for application of the present invention, since with such transducer the pressure waves can be very precisely controlled. By tuning the electrical pulse, a pressure wave can be obtained in each ink chamber leading to a predetermined ink droplet ejection speed despite mutually distinguishable acoustics in these chambers.

In a further embodiment, the transducer is used as a sensor for determining an acoustic effect of the applied pulse in between two consecutive pulses aimed at two consecutive ink droplet ejections. In this embodiment a transducer is used, which generates an electrical signal upon its deformation, e.g. a piezoelectric transducer. The pressure wave, which is induced in the ink, on its return will deform the electro-mechanical transducer. The transducer will then generate an electrical signal that corresponds to the pressure wave. By analyzing the generated signal, clear information is provided about the pressure wave induced in the chamber. This way, in between two consecutive ink droplet ejections, one can immediately see what the result of the electrical pulse is such that small deviations from the desired effect can be spotted immediately. These deviations can be taken into account, for example for a next droplet ejection by further adjusting the electrical pulse to better compensate for the actual acoustical deviations in the chamber. It is noted that in general it is known (e.g. from U.S. Pat. Nos. 6,682,162, 6,926,388 and 6,910,751) how to use an electro-mechanical transducer to obtain information about the pressure wave in an ink chamber. However, it is not known hitherto, or even hinted at, to use this information in conjunction with the present invention.

In a further embodiment, after a first of the two pulses is applied, an electrical connection between a generator of that pulse and the transducer is cut off. In this embodiment, the electrical connection between a generator of the pulse and the transducer is interrupted. Applicant has noted that the “rest-effect” of the pulse, as compared to the electrical signal generated by the transducer as a result of its deformation, is relatively large. To be able and measure the electrical signal generated by the transducer with great precision, applicant recognized that it is advantageous to rule out a contribution in the net electrical signal that originates from the pulse itself. By cutting off the connection between the generator of the pulse and the transducer, e.g. mechanically by use of a hardware switch, or by use of an electrical component that mimics the effect of a hardware switch, any contribution of the original pulse could be ruled out completely.

The present invention also pertains to an ink jet printer comprising a plurality of ink chambers operatively filled with ink, each chamber having a nozzle and a corresponding transducer and an operative connection to a pulse generator to apply an electrical pulse to the transducer in order to provide a pressure wave in the ink chamber, the printer comprising a controller arrangement that is devised in order to have the printer perform the method according to the present invention. Such a controller arrangement can be a single piece of hardware, such as an ASIC, but can also be devised as an arrangement being distributed over several components or even separate hardware devices, optionally partly or substantially completely constituted in software. For one having ordinary skill in the art, it will be clear that the actual constitution of the controller arrangement is not essential for enabling the application of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing an inkjet printer;

FIG. 2 is a diagram showing an inkjet print head;

FIGS. 3A and 3B illustrate an effect on droplet speed as a result of mutually distinguishable acoustics of two ink chambers;

FIG. 4 illustrates how a pulse is adjusted to the acoustics of a first chamber such that the speed at which the droplet is jetted is essentially the same as for a second chamber; and

FIG. 5 is a block diagram showing a circuit that is suitable for measuring the effect of the droplet ejection in the ink chamber by application of the transducer as a sensor.

### DETAILED DESCRIPTION OF THE PREFERRED EMBODIMENTS

The present invention will now be described with reference to the accompanying drawings, wherein the same reference numerals have been used to identify the same or similar elements throughout the several views.

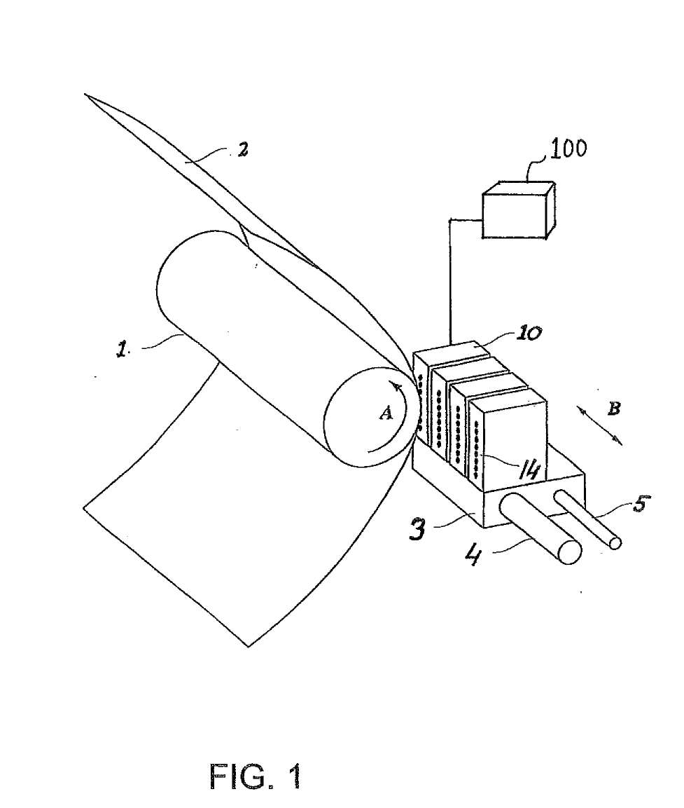

### FIG. 1

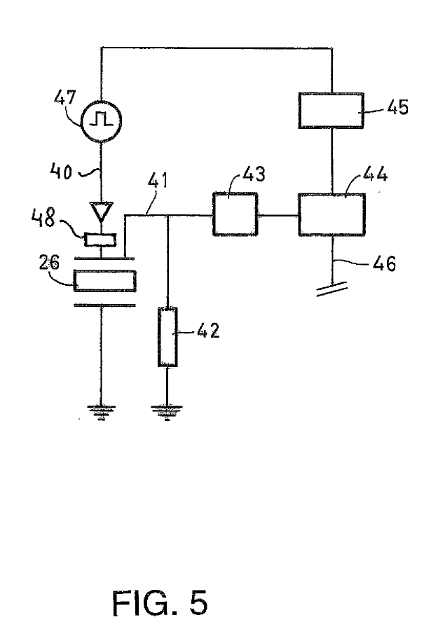

FIG. 1 diagrammatically illustrates an inkjet printer. In this embodiment, the printer comprises a roller 1 to support a receiving medium 2 (also referred to as receiving substrate) and move it along the four print heads 10. The roller 1 is rotatable about its axis as indicated by arrow A. A carriage 3 carries the four print heads 10, one for each of the colors cyan, magenta, yellow and black, and can be moved in reciprocation in a direction indicated by the double arrow B, parallel to the roller 1. In this way the print heads 10 can scan the receiving medium 2. The carriage 3 is guided on rods 4 and 5 and is driven by suitable means (not shown). In the embodiment as shown in the drawing, each print head 10 comprises eight ink chambers, each with its own exit opening 14 (also referred to as nozzle), which form an imaginary line perpendicular to the axis of the roller 1. In a practical embodiment of a printing apparatus, the number of ink chambers per print head 10 is many times greater. Each ink chamber is provided with a piezo-electric transducer (not shown) and associated actuation and measuring circuit (not shown) as described in connection with FIG. 5. Each of the print heads also contains a control unit (not shown) for adapting the actuation pulses, e.g. the amplitude and frequency of the pulse. The printer is also provided with a central controller arrangement 100 (controller). In this embodiment, the control units form part of this central controller arrangement 100. This arrangement also comprises the necessary components in order to enable the printer to perform the method according to the present invention. In this way, the ink chamber, transducer, actuation circuit, measuring circuit and controller arrangement form a system serving to eject ink drops in the direction of the roller 1.

A piezo-electric transducer may generate a pressure wave in the corresponding ink chamber so that an ink drop is ejected from the nozzle of this chamber in the direction of the receiving medium 2. This droplet then travels through the air in the direction of the medium. The exact location of placement of the droplet on the receiving medium depends, i.e. on the speed of the droplet. Since the speed aimed at is known beforehand, it can be calculated when each transducer should be actuated in order for a droplet to arrive at the intended location. The transducers are actuated image-wise via an associated electrical drive circuit (not shown) by application of the central control unit. In this manner, an image built up of ink drops may be formed on receiving medium 2.

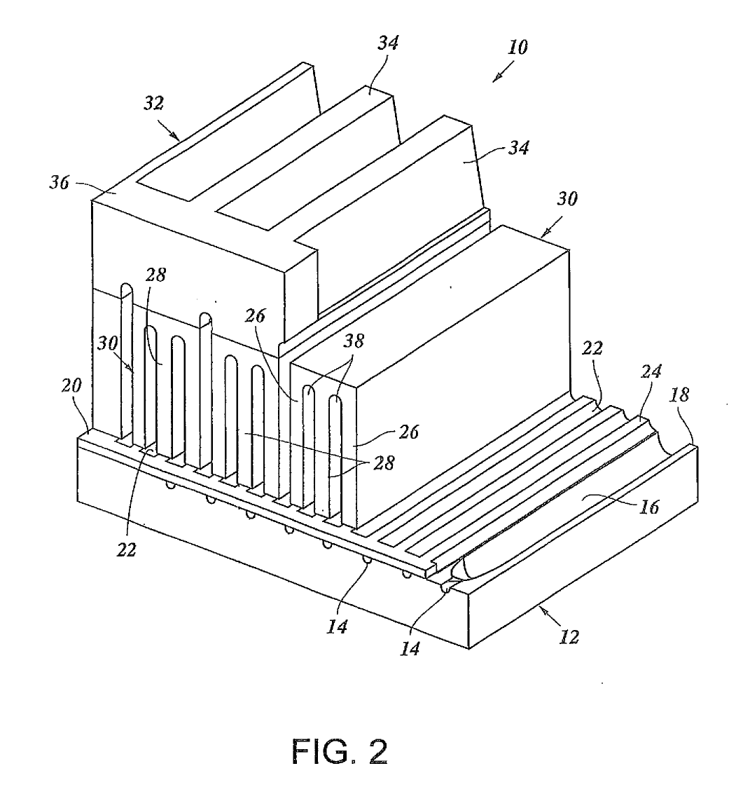

### FIG. 2

FIG. 2 diagrammatically illustrates a print head. The print head 10 illustrated comprises a chamber plate 12 defining a row of exit openings (nozzles) 14 and a number of parallel ink chambers 16. Only one of the ink chambers 16 is visible in FIG. 2. The exit openings 14 and the ink chambers 16 are formed by milling grooves in the top surface of the chamber plate 12. Each exit opening 14 is in communication with an associated ink chamber 16. The ink chambers are separated from one another by dams 18.

The exit openings 14 and ink chambers 16 are covered at the top by a thin flexible plate 20 rigidly connected to the dams of the chamber plate. A number of grooves 22 are formed in the top surface of the plate 20 and extend parallel to the ink chambers 16 and are separated from one another by ribs 24. The ends of the grooves 22 adjoining the exit openings 14 are somewhat offset from the edge of the plate 20.

A row of elongate fingers 26, 28 is so formed on the top surface of the plate 20 that each finger extends parallel to the ink chambers 16 and is connected at the bottom end to one of the ribs 24. The fingers are grouped in triplets, each triplet consisting of one central finger 28 and two lateral fingers 26. The fingers of each triplet are connected at the top and are formed by a block of piezo-electric material in one piece 30. Each of the fingers 26 belongs to one of these chambers 16 and is provided with electrodes (not shown) to which a pulse can be applied in accordance with a print signal. These fingers 26 are piezo-electric transducers that serve as actuators, which in response to the applied voltage of the pulse, expand and contract in the vertical direction so that the corresponding part of the plate 20 is bent towards the inside of the associated ink chamber 16 and back to their original position. As a consequence, the ink (for example aqueous ink, solvent ink or hot melt ink) present in the ink chamber is compressed, so that an ink drop is ejected from the exit opening 14. The central fingers 28 are disposed above the dams 18 of the chamber plate and serve as support elements, which take the reaction forces of the actuators 26. If, for example, one or both actuators 26 belonging to the same block 30 expand, they exert an upward force on the top part of block 30. This force is largely compensated by a tensile force of the support element 28, the bottom end of which is rigidly connected to the chamber plate 12 via rib 24 of the plate.

At the top, the blocks 30 bear flat against one another and are covered by a carrier member 32, which is formed by a number of longitudinal bars 34 extending parallel to the ink chambers 16, and by transverse bars 36 that interconnects the ends of the longitudinal bars 34.

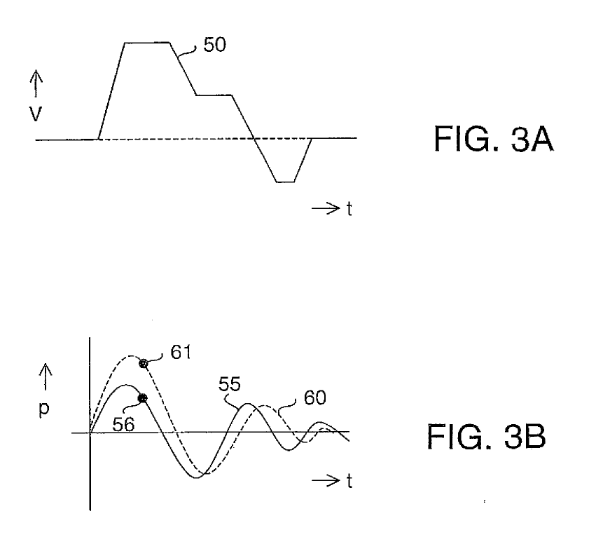

### FIGS. 3A and 3B

FIGS. 3A and 3B show an effect on droplet speed as a result of mutually distinguishable acoustics of two ink chambers. In FIG. 3A, an electrical pulse 50 is depicted, which pulse consists of a voltage step V to be applied during a time t. In this case, the pulse consists of a stepped voltage, a first part of which is positive (which for a print head 10 according to FIG. 2 corresponds to a contraction of the transducer), a second part of which is negative (which corresponds to an expansion of the transducer). After such a pulse is applied (voltage back to zero), then the transducer will adopt its original shape.

If this pulse is applied to two different transducers corresponding to two different ink chambers, an effect as depicted in FIG. 3B may arise. In this figure, vertically the pressure P is given as a function of the time t. Application of the pulse 50 in a first chamber leads to a pressure wave 55. An ink droplet will be ejected from this chamber at moment 56. The speed of the ejected droplet initially is 6.0 m/sec. In a second chamber, exactly the same voltage pulse 50 will lead to pressure wave 60. An ink droplet will be ejected from this second chamber at moment 61. The speed of the ejected droplet initially is 6.9 m/sec. The speed difference between the droplets is thus 13% with respect to the fastest droplet.

Thus, although the applied pulse to both transducers is exactly the same, the resulting pressure wave differs substantially. As a result, the speed at which the corresponding ink droplets are jetted out of the nozzles is different for these chambers. This can be attributed, at least to a substantial extent, to the difference in acoustics between the two chambers.

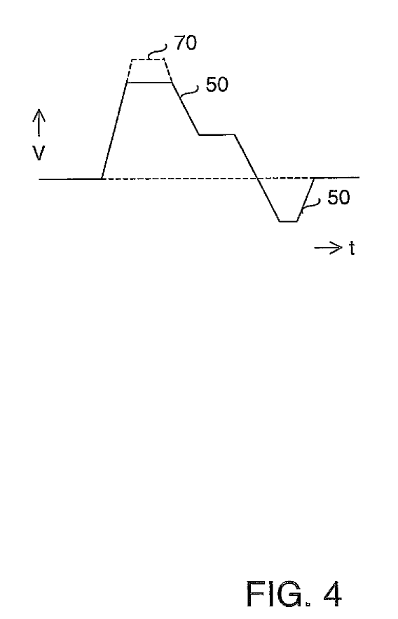

### FIG. 4

FIG. 4 shows how a pulse is adjusted to the acoustics of a first chamber such that the speed at which the droplet is jetted is essentially the same as for a second chamber. In this example, the same two chambers are contemplated, as is the case with reference to FIGS. 3A and 3B. In this example, the pulse 70 applied to the first chamber is somewhat different. Pulse 70 has an initial higher voltage (the dotted line shows the different part of pulse 70; for the rest pulse 70 is the same as pulse 50), such that the transducer will contract to a somewhat further extent as compared to the case wherein pulse 50 is applied to this chamber. As a result, the ink chamber will be filled with some more ink just before this chamber will be compressed by expansion of the transducer. This small change in pulse is enough to just compensate the acoustical differences between the first and second ink chamber. As a result of application of pulse 70, the pressure wave induced in the ink in the first chamber will lead to an ink droplet jetted out of this ink chamber at a speed of 6.8 m/sec, which is less than 2% lower than the speed of an ink droplet jetted out of the second chamber when voltage pulse 50 is applied to the transducer corresponding to the second chamber.

### FIG. 5

FIG. 5 is a block diagram showing a circuit that is suitable for measuring the effect of the droplet ejection in the ink chamber by application of the transducer as a sensor.

FIG. 5 shows a piezo-electric transducer 26 operatively connected to an ink chamber (not shown). This transducer can be energized by use of pulse generator 47. An electrical pulse is sent via line 40, through element 48 to transducer 26. The piezo-electric transducer 26 is connected via line 41 to resistor 42 and A/D converter 43. The latter is in turn connected to the control unit 44 provided with a processor (not shown). Control unit 44 (which in this embodiment is part of the central controller arrangement 100 as shown in FIG. 1) is connected to D/A converter 45, which can deliver signals to pulse generator 47. The control unit is connected via line 46 to other parts of the printer (not shown).

The following takes place when the method according to the present invention is applied. First of all, piezo-electric transducer 26 is energized via pulse generator 40. After the pulse has ended, component 48 cuts off the connection between pulse generator 40 and transducer 26. As a result of the energization of transducer 26, a pressure wave is provided in the ink chamber, which will lead to the ejection of an ink droplet from the ink chamber. The pressure wave will on its turn result in a deformation of piezo-electric transducer 26. As a result of this deformation, transducer 26 generates a current that will flow to earth via measuring resistor 42. The voltage thus available across measuring resistor 42 is fed to A/D converter 43, which transmits this voltage as a digital signal to control unit 44. This control unit analyzes the signal. In this way, even before a next ink droplet will be ejected, clear information can be provided about the circumstances in the chamber during the time the pressure waves run through the chamber. In other words, information can be gathered about the physical effect the droplet ejection step had in the chamber. If necessary, a signal is sent to pulse generator 47 via D/A converter 45 in order to adjust a subsequent actuation pulse to the current state of the chamber. The control of transducer 26 is initiated by control unit 44, which transmits a signal to D/A converter 45, which transmits the signal in analogue form to pulse generator 47. Finally, this pulse generator sends a pulse to transducer 26 suitable to actuate the latter so that a next ink drop is ejected from the corresponding chamber. Thus transducer 26 is provided with a measuring circuit, via line 41, and a control circuit, which in this embodiment partially overlap one another.

In this embodiment, not only is transducer 26 provided with its own measuring circuit, but all the piezo-electric transducers of the corresponding print head have a circuit of this kind. In order to maintain clarity, the other measuring circuits and piezo-electric transducers have not been shown in FIG. 5. This embodiment enables real-time decisions to be taken as to whether a change of circumstances have to be taken into account and how such a change can be compensated for.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for obtaining an image consisting of multiple ink droplets transferred to a receiving substrate using an ink jet printer comprising a plurality of ink chambers operatively filled with ink, each of the plurality of ink chambers having a nozzle and a corresponding transducer, each of the plurality of ink chambers having mutually distinguishable acoustics, the method comprising for each of the plurality of chambers the steps of:
generating an electrical pulse;
applying said electrical pulse to the transducer corresponding to a respective ink chamber in order to generate a pressure wave in the ink, such that a droplet of the ink is jetted out of the nozzle at a speed corresponding to the pressure wave; and
adjusting said electrical pulse to the acoustics of the respective ink chamber such that the speed at which the droplet is jetted is essentially the same for each of the plurality of ink chambers.

2. The method according to claim 1, wherein the transducer used is an electro-mechanical transducer that is operatively connected to the respective ink chamber.

3. The method according to claim 2, wherein the transducer is used as a sensor for determining an acoustic effect of the applied pulse in between two consecutive pulses aimed at two consecutive ink droplet ejections.

4. The method according to claim 3, wherein after a first of the two pulses is applied, an electrical connection between a generator of that pulse and the transducer is cut off.

5. An ink jet printer, comprising:
a plurality of ink chambers operatively filled with ink, each of the plurality of ink chambers having a nozzle and a corresponding transducer and an operative connection to a pulse generator to apply an electrical pulse to the transducer in order to provide a pressure wave in a respective ink chamber, the printer comprising a controller arrangement that is devised in order to have the printer perform a method for obtaining an image consisting of multiple ink droplets transferred to a receiving substrate, each of the plurality of ink chambers having mutually distinguishable acoustics, the method comprising for each of the plurality of chambers the steps of:
generating an electrical pulse;
applying said electrical pulse to the transducer corresponding to a respective ink chamber in order to generate a pressure wave in the ink, such that a droplet of the ink is jetted out of the nozzle at a speed corresponding to the pressure wave; and
adjusting said electrical pulse to the acoustics of the respective ink chamber such that the speed at which the droplet is jetted is essentially the same for each of the plurality of ink chambers.
